(19) United States
(12) Patent Application Publication
(10) Pub. No.: US 2021/0362539 A1
(43) Pub. Date: Nov. 25, 2021

(54) DEVICE FOR DRYING PAINTING TOOLS

(71) Applicant: Robert W. Steiner, Wilmington, NC (US)

(72) Inventor: Robert W. Steiner, Wilmington, NC (US)

(21) Appl. No.: 17/325,178

(22) Filed: May 19, 2021

Related U.S. Application Data
(60) Provisional application No. 63/026,915, filed on May 19, 2020.

(51) Int. Cl. B44D 3/12; A47J 47/20

(52) U.S. Cl. CPC B44D 3/125; A47J 47/20

(57) ABSTRACT

The present invention is a device for drying painting tools and the like. As a non-limiting, first embodiment, the device preferably includes a frame, at least one roller-securing element secured upon the frame, and at least one brush-securing element secured upon the frame. The device may also include at least one pad-securing element. Preferably, each of the at least one roller-securing element is dimensioned and configured for detachably securing at least one paint roller in a generally upright position during use. Preferably, each of the at least one brush-securing element is dimensioned and configured for detachably securing at least one paint brush in a generally upright position during use. As a non-limiting, second embodiment, the device includes a frame and at least one brush-securing element secured upon the frame. As a non-limiting, third embodiment, the device includes a frame and at least one roller-securing element secured upon the frame.

### CROSS-REFERENCE TO RELATED APPLICATIONS

The present application claims the priority benefit of U.S. Provisional Patent Application Ser. No. 63/026,915, filed on May 19, 2020 and titled “Drip-N-Dry Caddy,” which is incorporated herein by reference in its entirety.

### BACKGROUND OF THE INVENTION

### Field of the Invention

The present invention generally relates to machines, apparatuses, devices, and tools for drying painting tools and the like. More specifically, the present invention is a device for drying painting tools and the like.

### Description of the Related Art

Machines, apparatuses, devices, and tools for drying painting tools and the like are known in the art.

There are solutions for drying paint brushes and rollers. Some of these solutions attempt to dry a limited number of paint brushes or rollers but these solutions fail to meet the needs of the do-it-yourselfers because typical paint projects often require multiple paint brushes, paint rollers of different sizes, edgers or trim and touch up accessories. Other solutions attempt to dry painting accessories by mechanically spinning them in large buckets. Unfortunately, the frequent and vigorous pushing and pulling action to produce the spinning action is prone to eventual mechanical failure. Other solutions require the use of a power drill to create the necessary spinning motion.

Accordingly, it is desirable to have a device that prolongs the life of painting tools, and saves space, while improving the way in which painting tools are cleaned and dried that uses the interior of an applicable sink, such as, but not limited to, a utility or kitchen sink.

Furthermore, it would also be desirable to have a device that helps painting tools dry more efficiently due to the vertical orientation of the tools during the air drying process.

In addition, it would be desirable to have a single device that can detachably secure and allow multiple brushes, rollers, and edging tools to air dry at the same time.

The Applicant is unaware of inventions or patent documents, taken either singly or in combination, which are seen to describe the present invention as claimed.

### SUMMARY OF THE INVENTION

The present invention is a device for drying painting tools and the like. As a non-limiting, first embodiment, the device preferably comprises a frame, at least one roller-securing element secured upon the frame, and at least one brush-securing element secured upon the frame. The device may also comprise at least one pad-securing element.

The frame is dimensioned and configured to be supported by an environmental structure, such as, but not limited to, an applicable sink, preferably a rim or top edge of an applicable sink, such as, but not limited to, a utility or kitchen sink. The frame comprises a first end, a second end, a frame body, and a top side. The frame body extends from the first end to the second end. Preferably, the frame also comprises a first or front side and a second or rear side such that the top side, the front side, and the rear side define a hollow frame to be positioned over and detachably secured to the rim of the sink during use. Preferably, each of the front side and rear side extends downward a sufficient distance from the top side such that the frame can withstand the weights of the secured painting tools and gravity and maintain stability when the frame is positioned over and detachably secured to the rim of the sink during use.

Preferably, each of the at least one roller-securing element is dimensioned and configured for detachably securing at least one paint roller such that the paint roller is able to be air dried in a generally upright or vertical position during use.

Preferably, each of the at least one brush-securing element is dimensioned and configured for detachably securing at least one paint brush such that the paint brush(es) is able to be air dried in a generally upright or vertical position during use.

Preferably, the at least one pad-securing element is dimensioned and configured for receiving and supporting a pad tool.

As a non-limiting, second embodiment, the device comprises a frame and at least one brush-securing element secured upon the frame.

As a non-limiting, third embodiment, the device comprises a frame and at least one roller-securing element secured upon the frame.

### BRIEF DESCRIPTION OF THE DRAWINGS

FIG. 1 is a front view of an embodiment of a device for drying painting tools according to the present invention;

FIG. 2 is a rear view of the device for drying painting tools of FIG. 1;

FIG. 3 is a right side view of the device for drying painting tools of FIG. 1;

FIG. 4 is a left side view of the device for drying painting tools of FIG. 1;

FIG. 5 is a top view of the device for drying painting tools of FIG. 1;

FIG. 6 is a bottom view of the device for drying painting tools of FIG. 1;

FIG. 7 is an environmental, perspective, front view of the device for drying painting tools of FIG. 1;

FIG. 8 is a perspective, front, right side view of another embodiment of a device for drying painting tools according to the present invention;

FIG. 9 is a perspective, rear, right side view of the device for drying painting tools of FIG. 8;

FIG. 10 is an environmental, perspective, front, right side view of the device for drying painting tools of FIG. 8;

FIG. 11 is a perspective, front, right side view of a further embodiment of a device for drying painting tools according to the present invention;

FIG. 12 is a perspective, rear, right side view of the device for drying painting tools of FIG. 11; and

FIG. 13 is an environmental, perspective, front, right side view of the device for drying painting tools of FIG. 11.

It should be understood that the above-attached figures are not intended to limit the scope of the present invention in any way.

### DETAILED DESCRIPTION OF THE EMBODIMENTS OF THE PRESENT INVENTION

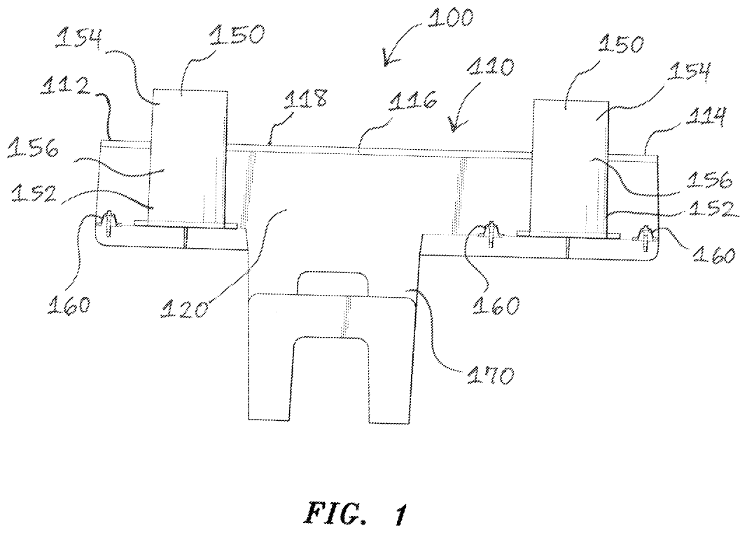

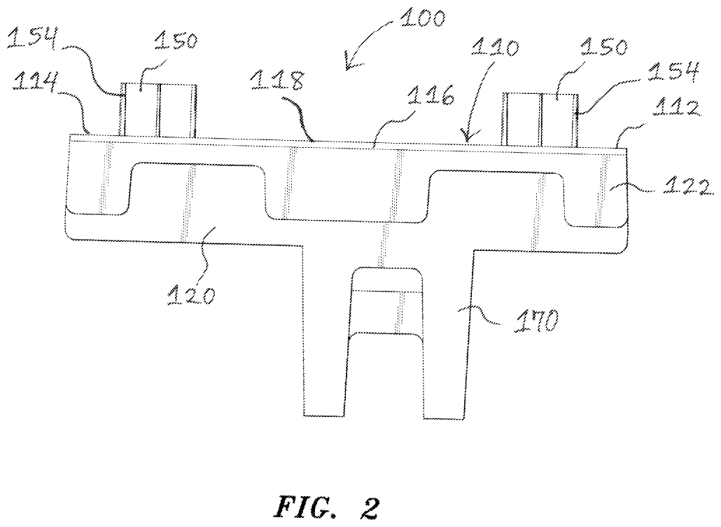

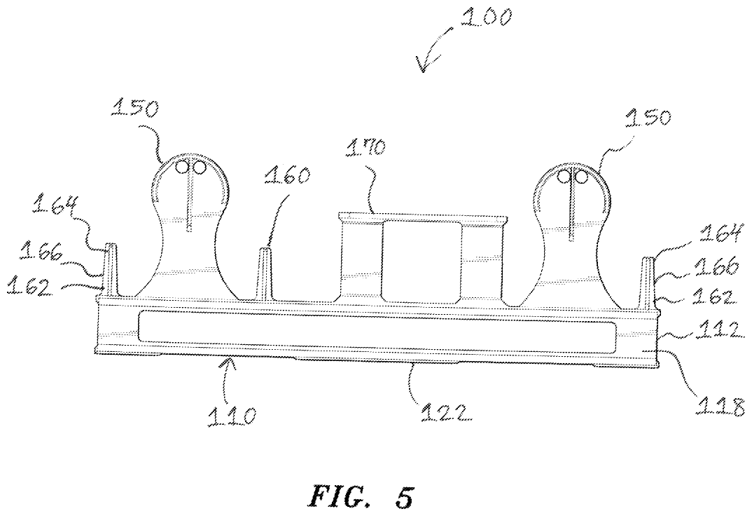

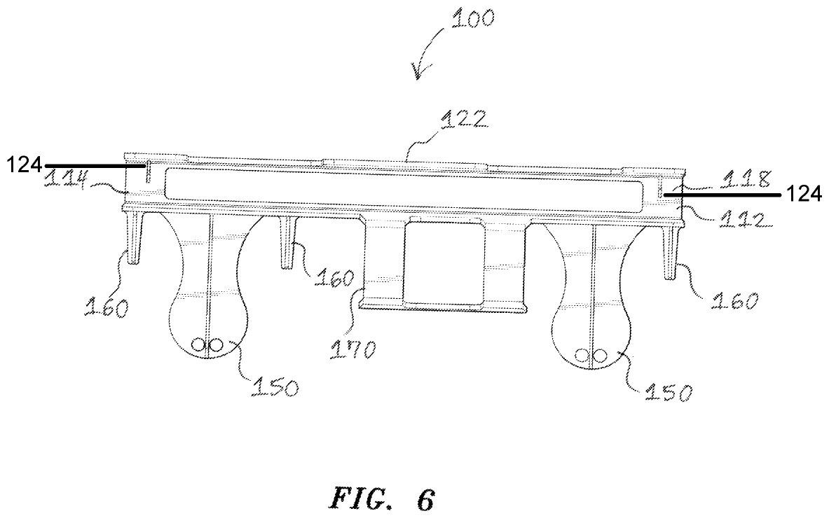

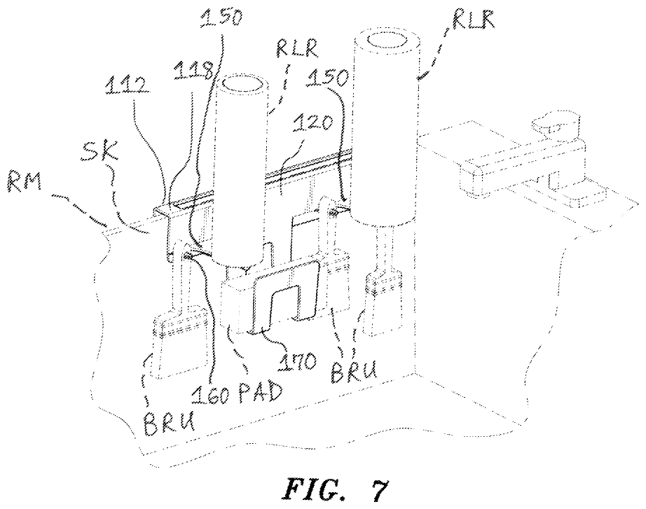

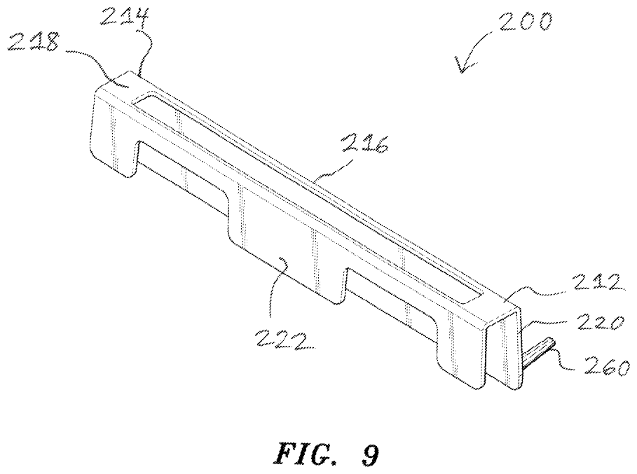

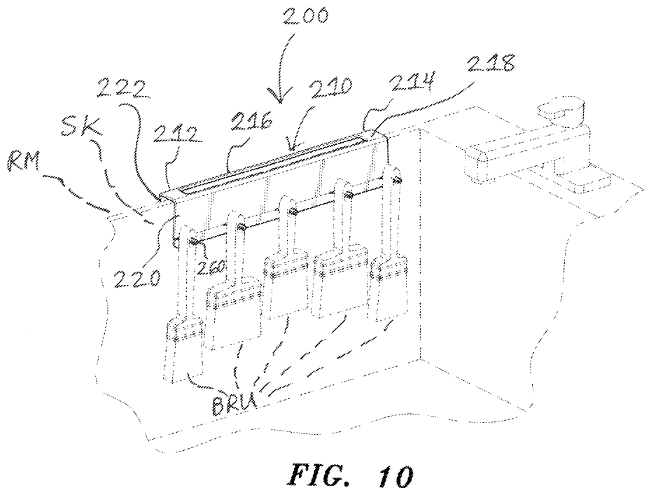

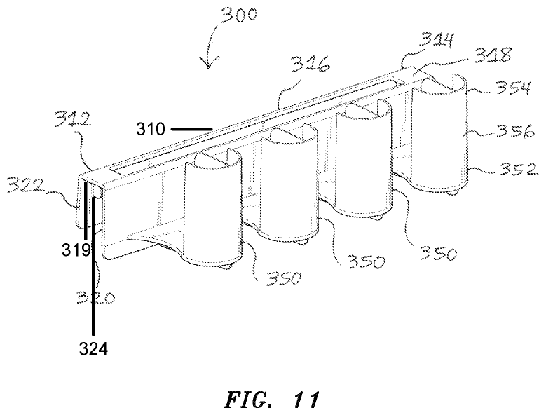

Referring to FIGS. 1-13, the present invention is a device 100,200,300 for drying painting tools and the like.

Referring to FIGS. 1-7, a non-limiting, first embodiment of a device 100 for drying painting tools and the like preferably comprises a frame 110, at least one roller-securing element 150 secured upon the frame 110, and at least one brush-securing element 160 secured upon the frame 110. The device 100 may also comprise at least one pad-securing element 170.

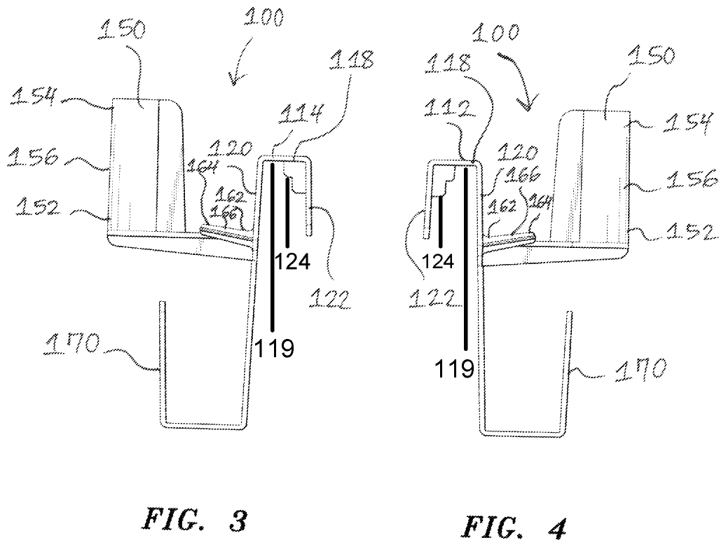

As shown in FIGS. 1-7, the frame 110 is dimensioned and configured to be supported by an environmental structure, such as, but not limited to, an applicable sink SK, preferably a rim or top edge RM of an applicable sink SK, such as, but not limited to, a utility or kitchen sink. The frame 110 comprises a first end 112, a second end 114, a frame body 116, and a top side 118. The frame body 116 extends from the first end 112 to the second end 114. Preferably, the frame 110 also comprises a first or front side 120 and a second or rear side 122 such that the top side 118, the front side 120, and the rear side 122 define a hollow frame to be positioned over and detachably secured to the rim RM of the sink SK during use. Preferably, each of the front side 120 and rear side 122 extends downward a sufficient distance from the top side 118 such that the frame 110 can withstand the weights of the secured painting tools and gravity and maintain stability when the frame 110 is positioned over and detachably secured to the rim RM of the sink SK during use. Preferably, the frame 110 is dimensioned and configured to fit snuggly with the rim RM of the sink SK during use. On the bottom surface 119 of the top side 118, there is a staircase-like feature 124, as best shown in FIGS. 3, 4 and 6, that enables the frame 110 to securely fit over rims of applicable sinks SK of different thicknesses.

Preferably, as best shown in FIGS. 1-4, the at least one roller-securing element 150 is a plurality of roller-securing elements 150. Preferably, each of the at least one roller-securing element 150 comprises a first or lower end 152, a second or upper end 154, and a body 156 extending from the first end 152 to the second end 154 of the at least one roller-securing element 150. Preferably, each of the at least one roller-securing element 150 has a generally upright or vertical configuration. As a non-limiting example and as shown in FIGS. 1-4, each of the at least one roller-securing element 150 is a half-circle sleeve. Preferably, each roller-securing element 150 extends or is positioned forward of the first or front side 120 of the frame 110 of a sufficient distance such that at least one paint roller RLR that is secured to a corresponding roller-securing element 160 will not make contact with any surface, such as, but not limited to, a side of an applicable sink, of the environmental structure so that the secured paint roller(s) RLR will be able to be air dried quicker and will not dirty the environmental structure. Preferably, each of the at least one roller-securing element 150 is dimensioned and configured for receiving and detachably securing at least one paint roller RLR by fitting within a chamber of the paint roller RLR such that the paint roller RLR is able to be air dried in a generally upright or vertical position during use. As a non-limiting example, at least one of the roller-securing elements 150 is a series of roller-securing elements 150 positioned forward of the front side 120 wherein the series of roller-securing elements 150 has a length of up to several inches to accommodate multiple rollers RLR on the applicable series of roller-securing elements 150.

Preferably, as best shown in FIGS. 3-7, the at least one brush-securing element 160 is a plurality of brush-securing elements 160. Preferably, the at least one brush-securing element 160 comprises a first end 162, a second end 164, and a body 166 extending from the first end 162 to the second end 164 of the at least one brush-securing element 160. Preferably, each of the at least one brush-securing element 160, such as, but not limited to, a peg, has a generally horizontal configuration, when secured to the frame 110, that is preferably slightly angled upward relative to a horizontal plane so as to better prevent at least one paint brush BRU or other paint application implements with a hole in the handle that is secured to a corresponding brush-securing element 160 from falling off the brush-securing element 160 easily. Preferably, each brush-securing element 160 extends or is positioned forward of the first or front side 120 of the frame 110 of a sufficient distance such that at least one paint brush BRU or other paint application implements with a hole in the handle that is secured to a corresponding brush-securing element 160 will not make contact with any surface of the environmental structure so that the secured paint brush(es) BRU will be able to be air dried quicker and will not dirty the environmental structure. Each of the at least one brush-securing element 160 is dimensioned and configured for receiving and detachably securing at least one paint brush BRU or other paint application implements with a hole in the handle such that the paint brush(es) BRU or other paint application implements with a hole in the handle is able to be air dried in a generally upright or vertical position during use. Non-limiting examples of the brush-securing element 160 are a peg, a hook, any securing element known to one of ordinary skill in the art, and any combination thereof. As a non-limiting example, at least one of the brush-securing elements 160 has a length of up to several inches to accommodate multiple brushes or other paint application implements with a hole in the handle on the applicable brush-securing element 160.

Preferably, the at least one pad-securing element 170 extends or is positioned downward and/or forward of the first or front side 120 of the frame 110 of a sufficient distance such that a pad tool PAD (such as, but not limited to, a cleaning pad, a paint pad, a paint edger, and the like) that is secured to a corresponding pad-securing element 170 will not make contact with any surface of the environmental structure so that the secured pad tool PAD will be able to be air dried quicker and will not dirty the environmental structure. Preferably, the at least one pad-securing element 170 is dimensioned and configured to receive and support a pad tool PAD. A non-limiting example of the pad-securing element 170 has a “J-shape” configuration and is best shown in FIGS. 1-4 and 7.

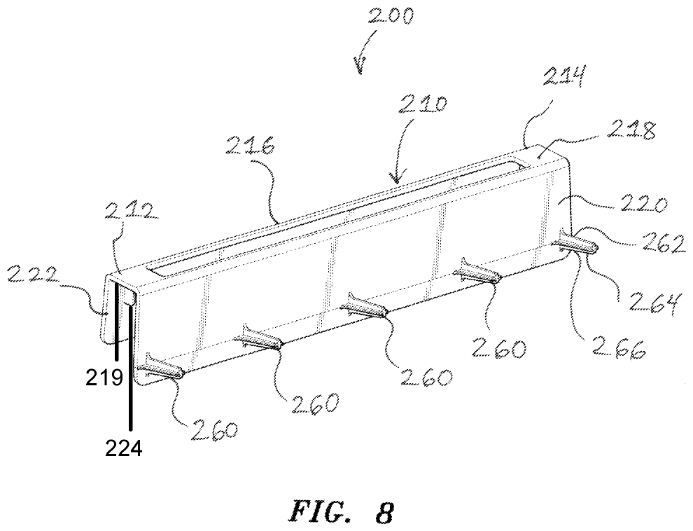

Referring to FIGS. 8-10, a non-limiting, second embodiment of a device 200 for drying painting tools and the like preferably comprises a frame 210 and at least one brush-securing element 260 secured upon the frame 210.

The frame 210 is dimensioned and configured to be supported by an environmental structure, such as, but not limited to, an applicable sink SK, preferably a rim or top edge RM of an applicable sink SK, such as, but not limited to, a utility or kitchen sink. The frame 210 comprises a first end 212, a second end 214, a frame body 216, and a top side 218. The frame body 216 extends from the first end 212 to the second end 214. Preferably, the frame 210 also comprises a first or front side 220 and a second or rear side 222 such that the top side 218, the front side 220, and the rear side 222 define a hollow frame to be positioned over and detachably secured to the rim RM of the sink SK during use. Preferably, each of the front side 220 and rear side 222 extends downward a sufficient distance from the top side 218 such that the frame 210 can withstand the weights of the secured painting tools and gravity and maintain stability when the frame 210 is positioned over and detachably secured to the rim RM of the sink SK during use. Preferably, the frame 210 is dimensioned and configured to fit snuggly with the rim RM of the sink SK during use. On the bottom surface 219 of the top side 218, there is a staircase-like feature 224, as best shown in FIG. 8, that enables the frame 210 to securely fit over rims of applicable sinks SK of different thicknesses.

Preferably, the at least one brush-securing element 260 is a plurality of brush-securing elements 260. Preferably, the at least one brush-securing element 260 comprises a first end 262, a second end 264, and a body 266 extending from the first end 262 to the second end 264 of the at least one brush-securing element 260. Preferably, each of the at least one brush-securing element 260, such as, but not limited to, a peg, has a generally horizontal configuration, when secured to the frame 210, that is preferably slightly angled upward relative to a horizontal plane so as to better prevent at least one paint brush BRU or other paint application implements with a hole in the handle that is secured to a corresponding brush-securing element 260 from falling off the brush-securing element 260 easily. Preferably, each brush-securing element 260 extends or is positioned forward of the first or front side 220 of the frame 210 of a sufficient distance such that at least one paint brush BRU or other paint application implements with a hole in the handle that is secured to a corresponding brush-securing element 260 will not make contact with any surface of the environmental structure so that the secured paint brush(es) BRU or other paint application implements with a hole in the handle will be able to be air dried quicker and will not dirty the environmental structure. Each of the at least one brush-securing element 260 is dimensioned and configured for receiving and detachably securing at least one paint brush BRU or other paint application implements with a hole in the handle such that the paint brush(es) BRU or other paint application implements with a hole in the handle is able to be air dried in a generally upright or vertical position during use. Non-limiting examples of the brush-securing element 260 are a peg, a hook, any securing element known to one of ordinary skill in the art, and any combination thereof. As a non-limiting example, at least one of the brush-securing elements 260 has a length of up to several inches to accommodate multiple brushes or other paint application implements with a hole in the handle on the applicable brush-securing element 260.

Referring to FIGS. 11-13, a non-limiting, third embodiment of a device 300 for drying painting tools and the like preferably comprises a frame 310 and at least one roller-securing element 360 secured upon the frame 310.

The frame 310 is dimensioned and configured to be supported by an environmental structure, such as, but not limited to, an applicable sink SK, preferably a rim or top edge RM of an applicable sink SK, such as, but not limited to, a utility or kitchen sink. The frame 310 comprises a first end 312, a second end 314, a frame body 316, and a top side 318. The frame body 316 extends from the first end 312 to the second end 314. Preferably, the frame 310 also comprises a first or front side 320 and a second or rear side 322 such that the top side 318, the front side 320, and the rear side 322 define a hollow frame to be positioned over and detachably secured to the rim RM of the sink SK during use. Preferably, each of the front side 320 and rear side 322 extends downward a sufficient distance from the top side 318 such that the frame 310 can withstand the weights of the secured painting tools and gravity and maintain stability when the frame 310 is positioned over and detachably secured to the rim RM of the sink SK during use. Preferably, the frame 310 is dimensioned and configured to fit snuggly with the rim RM of the sink SK during use. On the bottom surface 319 of the top side 318, there is a staircase-like feature 324, as best shown in FIG. 11, that enables the frame 310 to securely fit over rims of applicable sinks SK of different thicknesses.

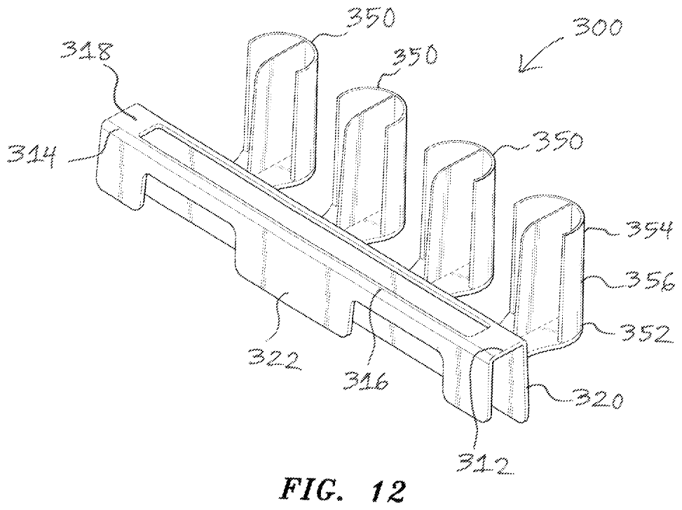

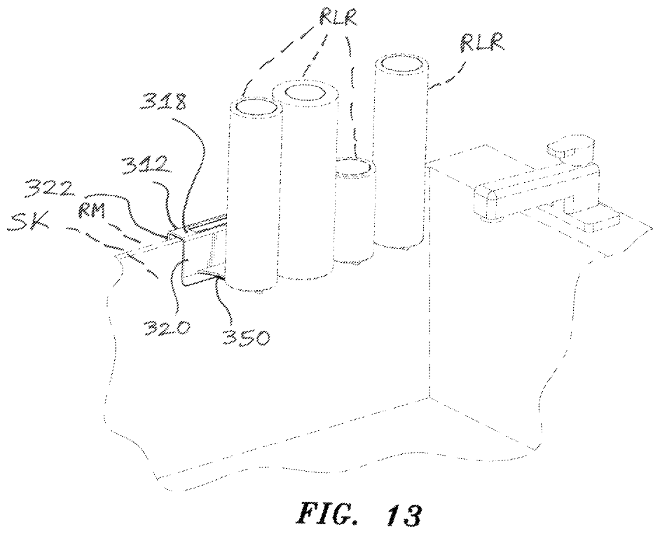

Preferably, the at least one roller-securing element 350 is a plurality of roller-securing elements 350. Preferably, each of the at least one roller-securing element 350 comprises a first or lower end 352, a second or upper end 354, and a body 356 extending from the first end 352 to the second end 354 of the at least one roller-securing element 350. Preferably, each of the at least one roller-securing element 350 has a generally upright or vertical configuration. As a non-limiting example and as shown in FIGS. 11 and 12, each of the at least one roller-securing element 350 is a half-circle sleeve. Preferably, each roller-securing element 350 extends or is positioned forward of the first or front side 320 of the frame 310 of a sufficient distance such that at least one paint roller RLR that is secured to a corresponding roller-securing element 360 will not make contact with any surface, such as, but not limited to, a side of a sink, of the environmental structure so that the secured paint roller(s) RLR will be able to be air dried quicker and will not dirty the environmental structure. Preferably, each of the at least one roller-securing element 350 is dimensioned and configured for receiving and detachably securing at least one paint roller RLR by fitting within a chamber of the paint roller RLR such that the paint roller RLR is able to be air dried in a generally upright or vertical position during use. As a non-limiting example, at least one of the roller-securing elements 350 is a series of roller-securing elements 350 positioned forward of the front side 320 wherein the series of roller-securing elements 350 has a length of up to several inches to accommodate multiple rollers RLR on the applicable series of roller-securing elements 350.

Preferably, with regard to each embodiment of the device 100,200,300, the at least one roller-securing element 150,350 and the at least one brush-securing element 160,260 are spaced at distances sufficiently away from one another along the front side 120,220,320 to allow all painting tools of the at least one roller-securing element 150,350 and the at least one brush-securing element 160,260 to be able to be air dried efficiently.

Preferably, the device 100,200,300 or frame 110,210,310 is made or manufactured of a plastic material. Preferably, the device 100,200,300 or frame 110,210,310 is made or manufactured of a lightweight material. Preferably, the frame 110,210,310 is made or manufactured of a strong and durable material that can withstand the weights of the secured painting tools and gravity during use. As a non-limiting example, the device 100,200,300 is made or manufactured as a one-piece molded device.

It is to be understood that the present invention is not limited to the embodiments and non-limiting examples described above or as shown in the attached figures, but encompasses any and all embodiments within the spirit of the invention.

1. A device for drying painting tools comprising:
a frame dimensioned and configured to be supported by a sink,
wherein said a frame comprises a first end, a second end, a frame body, and a top side,
wherein said frame body extends from said first end to said second end;
at least one roller-securing element secured upon said frame,
wherein said at least one roller-securing element is dimensioned and configured for receiving and detachably securing a paint roller such that the paint roller is able to be air dried in a generally upright position; and
at least one brush-securing element secured upon said frame,
wherein said at least one brush-securing element is dimensioned and configured for receiving and detachably securing a paint brush such that the paint brush is able to be air dried in a generally upright position.

2. The device for drying painting tools according to claim 1, wherein said frame further comprises a front side.

3. The device for drying painting tools according to claim 2, wherein said at least one roller-securing element extends forward of said front side of said frame.

4. The device for drying painting tools according to claim 2, wherein said at least one brush-securing element extends forward of said front side of said frame.

5. The device for drying painting tools according to claim 1, wherein said at least one roller-securing element comprises a first end, a second end, and a body extending from said first end to said second end of said at least one roller-securing element, wherein said at least one roller-securing element has a generally upright configuration, and wherein said at least one roller-securing element is dimensioned and configured to be positioned inside a chamber of the paint roller during use.

6. The device for drying painting tools according to claim 1, wherein said at least one brush-securing element comprises a first end, a second end, and a body extending from said first end to said second end of said at least one brush-securing element.

7. The device for drying painting tools according to claim 1, wherein said frame further comprises a rear side.

8. The device for drying painting tools according to claim 7, wherein said frame further comprises a front side, and wherein said front side, said rear side, and said top side of said frame define a hollow frame to be positioned over and detachably secured to a rim of the sink during use.

9. The device for drying painting tools according to claim 1, wherein said frame is dimensioned and configured to be positioned over and detachably secured to a rim of the sink during use.

10. The device for drying painting tools according to claim 1, wherein said frame further comprises a pad-securing element.

11. The device for drying painting tools according to claim 1, wherein said frame further comprises a fit adjustment element.

12. A device for drying painting tools comprising:
a frame dimensioned and configured to be supported by a sink,
wherein said frame comprises a first end, a second end, a frame body, and a top side,
wherein said frame body extends from said first end to said second end; and
at least one roller-securing element secured upon said frame,
wherein said at least one roller-securing element is dimensioned and configured for receiving and detachably securing a paint roller such that the paint roller is able to be air dried in a generally upright position.

13. The device for drying painting tools according to claim 12, wherein said frame further comprises a front side.

14. The device for drying painting tools according to claim 13, wherein said at least one roller-securing element extends forward of said front side of said frame.

15. The device for drying painting tools according to claim 12, wherein said at least one roller-securing element comprises a first end, a second end, and a body extending from said first end to said second end of said at least one roller-securing element, wherein said at least one roller-securing element has a generally upright configuration, and wherein said at least one roller-securing element is dimensioned and configured to be positioned inside a chamber of the paint roller during use.

16. The device for drying painting tools according to claim 12, wherein said frame further comprises a rear side.

17. The device for drying painting tools according to claim 16, wherein said frame further comprises a front side, and wherein said front side, said rear side, and said top side of said frame define a hollow frame to be positioned over and detachably secured to a rim of the sink during use.

18. The device for drying painting tools according to claim 12, wherein said frame is dimensioned and configured to be positioned over and detachably secured to a rim of the sink during use.

19. The device for drying painting tools according to claim 12, wherein said frame further comprises a fit adjustment element.

20. A device for drying painting tools comprising:
a frame dimensioned and configured to be supported by a sink,
wherein said frame comprises a first end, a second end, a frame body, and a top side,
wherein said frame body extends from said first end to said second end; and
at least one brush-securing element secured upon said frame,
wherein said at least one brush-securing element is dimensioned and configured for receiving and detachably securing a paint brush such that the paint brush is able to be air dried in a generally upright position.

21. The device for drying painting tools according to claim 20, wherein said frame further comprises a front side.

22. The device for drying painting tools according to claim 21, wherein said at least one brush-securing element extends forward of said front side of said frame.

23. The device for drying painting tools according to claim 20, wherein said at least one brush-securing element comprises a first end, a second end, and a body extending from said first end to said second end of said at least one brush-securing element.

24. The device for drying painting tools according to claim 20, wherein said frame further comprises a rear side.

25. The device for drying painting tools according to claim 24, wherein said frame further comprises a front side, and wherein said front side, said rear side, and said top side of said frame define a hollow frame to be positioned over and detachably secured to a rim of the sink during use.

26. The device for drying painting tools according to claim 20, wherein said frame is dimensioned and configured to be positioned over and detachably secured to a rim of the sink during use.

27. The device for drying painting tools according to claim 20, wherein said frame further comprises a fit adjustment element.
